(19) United States
(12) Patent Application Publication
(10) Pub. No.: US 2010/0109416 A1
(43) Pub. Date: May 6, 2010

(54) ADJUSTABLE SAFETY HARNESS

(76) Inventor: MARGARET L. JONES, Portales, NM (US)

Correspondence Address: Susanne Moore;MCCLESKEY, HARRIGER, BRAZILL & GRAF, LLP, 5010 UNIVERSITY, Lubbock, TX, 79413, US

(21) Appl. No.: 12/609,166

(22) Filed: Oct. 30, 2009

Related U.S. Application Data
(60) Provisional application No. 61/110,815, filed on Nov. 3, 2008.

(51) Int. Cl. A62B 35/00

(52) U.S. Cl. 297/468

(57) ABSTRACT

An adjustable harness for restricting a person's movement while in a professional services chair, having a waist strap, a crotch strap, two shoulder straps, and a front cross piece, each coupled together in front of the person by permanent stitching, and each extending over the front of the person's torso and coupling together behind the chair with adjustable fasteners and at least one slidable ring.

### CROSS REFERENCE TO RELATED APPLICATIONS

This application claims the benefit of provisional patent application 61/110,815 filed Nov. 3, 2008 by the present inventor and the application is hereto incorporated by reference in its entirety.

### STATEMENT REGARDING FEDERALLY SPONSORED RESEARCH OR DEVELOPMENT

Not Applicable

### NAMES OF PARTIES TO JOINT RESEARCH AGREEMENT

Not Applicable

### REFERENCE TO SEQUENCE LISTING

Not Applicable

### DESCRIPTION OF ATTACHED APPENDIX

Not Applicable

### BACKGROUND OF THE INVENTION

1. Field of the Invention

This invention relates generally to safety and restraint equipment to keep a person safely still during a professional service, and specifically adjustable safety harnesses for use on children when having their hair cut.

2. Description of Related Art

The prior art describes many devices for preventing children from falling from various seated heights, such as chairs, strollers, highchairs and grocery carts. Many of these devices are complex, cumbersome and expensive to manufacture. No prior art, however, was located that was designed specifically for, nor was suitable for, use in a professional services chair, such as a hydraulic chair. The prior art child safety harnesses are designed primarily to prevent the child from falling, or escaping. Because the prior art harnesses are geared more toward the prevention of falling, or actual escaping, they are bulkier, more restrictive and more complex than what would be appropriate for use to restrict the movement of a person in a professional services chair.

The prior art includes U.S. Pat. No. 7,073,866 directed to a fully adjustable universal safety harness or restraint for small children, designed to secure them in various chairs, high chairs, booster seats, shopping carts or strollers, or to control their movement. The restraint has a harness which fits over the child's shoulders and fully wraps around the chest and waist, including a separate strap, swivel hooks, belt loops and several D rings. U.S. Pat. No. 6,095,613 entitled Multi-Purpose Child Safety Harness is directed to a harness that is wearable and is used to support, hold, restrain, and protect a child during a variety of the child's activities. The harness includes a torso band, a pair of shoulder straps, an inner crotch strap, an outer crotch strap, and underarm securing straps. Once again the waist belt portion fully covers the lower torso and is quite restrictive.

These and similar patents involve restraints with numerous or complex parts that are relatively bulky and restrictive to the user. They are not designed to fit a professional services chair. They are not specifically designed to keep the child or person still, while minimally restraining them, so they can safely undergo a professional service or procedure.

### SUMMARY OF THE INVENTION

The disadvantages shown in the prior art are solved by the disclosure herein of a simple adjustable harness restraint, specifically designed to keep the person safely still while in a professional services chair, such as a hydraulic chair, while undergoing a procedure, such as a haircut. During a professional services visit, such as a dentist appointment or a haircut in a salon, professionals work with the person using potentially sharp instruments. It is imperative that the person feel safe, comfortable and minimally restrained, yet that the person be kept still so the professional can perform the procedure. As an example, it is very difficult for a hair stylist to cut a child's hair while the child is wriggling, twisting and turning in the salon chair.

To overcome the gaps in the prior art, the disclosed invention depicts an adjustable harness for restricting a person's movement while in a professional services chair. The harness is primarily targeted for small children, in order to restrict their movement enough to allow the professional to complete the procedure safely and quickly. The harness could also be used, however for mentally or physically challenged older children or adults, who may have difficulty restricting their own movements.

More particularly, the harness is minimalistic, comprising only five straps, none of which are bulky. In its minimalistic design, the harness is more similar to a seatbelt than to the prior art harnesses seen in the prior art, several of which fit over the child or person's head like a straitjacket.

The minimalist approach offers several advantages. First, the simple straps do not feel overly restrictive, bulky or binding to the wearer. This is important as children or those who are mentally or physically challenged are more likely to wear the harness as a result of its comfort and simplicity. Second, the harness, due to its simple design that simply straps the person to the chair, is extremely easy to apply and remove; literally only taking seconds. Again this is important as the target classes described above are unlikely to exhibit much patience while the professional is attaching or removing the harness. Because the strap system of the harness is somewhat similar to a seat belt or car seat harness, it should look and feel familiar to the child or person, encouraging acceptance.

Third, the harness, not having a great deal of surface area, is easy to keep clean.

Fourth, the harness is specifically created to accommodate not only a hydraulic chair, but also a booster seat, which children often sit on while in the hydraulic chair, undergoing a procedure such as a haircut or dental procedure.

In the preferred embodiment, the harness comprises a waist strap, a crotch strap, two shoulder straps, and a front cross strap. The waist strap travels across the child's waist, encircling the chair with the two ends coupling together behind the chair using an adjustable slide fastener. The crotch strap is sewn to the front midpoint of the waist strap and travels vertically down between the child's legs, under the booster seat (if one is used) and then up the posterior back of the chair, where it couples to the rear midpoint of the waist strap by an adjustable fastener.

Two shoulder straps are sewn to the front of the waist strap, one on either side of the crotch strap. The shoulder straps travel up the front of the person's torso and continuing over the person's shoulders. The shoulders strap travel down the person's back in a criss-cross or X pattern. At the middle point of the X, the shoulder straps pass through a slidable D or O ring which holds the straps in place. The shoulder straps continue down and couple to the rear of the waist strap with two adjustable fasteners.

The front cross piece holds the shoulder straps in position and keeps them from sliding off the person's shoulders. The front cross piece may be permanently sewn to the shoulder straps or each end of the front cross piece may be folded over the width of the shoulder straps and the ends of the cross piece sewn to itself to create a loop for the shoulder straps to pass through.

Other advantages of the present invention will become apparent from the following descriptions, taken in connection with the accompanying figures, wherein, by way of illustration and example, an embodiment of the present invention is disclosed.

### BRIEF DESCRIPTION OF THE DRAWINGS

The application makes no claim for the structure of the objects depicted in the photos and drawings, such as a hydraulic chair and booster seat, with which the harness is used, and they are considered prior art.

For a detailed description of various embodiments, reference will now be made to the accompanying figures and photos in which:

FIG. 1 shows a front view of the preferred embodiment of the disclosed invention.

FIG. 2 shows a side view of the preferred embodiment of the disclosed invention.

FIG. 3 shows a rear view of the preferred embodiment of the disclosed invention.

FIG. 4 shows a close up view of the preferred embodiment of the disclosed invention.

FIG. 5 shows a front view of the preferred embodiment of the disclosed invention.

### DETAILED DESCRIPTION OF THE DRAWINGS

Certain terms are used throughout the following description to refer to particular system components. As one skilled in the art will appreciate, design and manufacturing companies may refer to a component by different names. This document does not intend to distinguish between components that differ in name but not function.

In the following discussion, the terms “including” and “comprising” are used in an open-ended fashion, and thus should be interpreted to mean “including, but not limited to . . . .”Also, the term “couple” or “couples” is intended to mean either an indirect or direct connection. Thus, if a first device couples to a second device, that connection may be through a direct connection or through an indirect connection via other intermediate devices and connections. Moreover, the term “system” means “one or more components” combined together. Thus, a system can comprise an “entire system” or “subsystems” within the system. “Adjustable fastener” may include adjustable slide buckles, double rings, slidable rings, or any other appropriate device to adjustably fasten two ends of a strap.

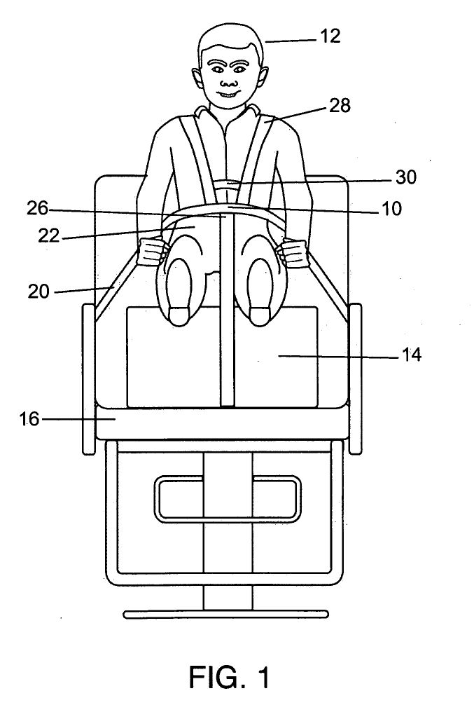

Turning to the drawings, FIG. 1 illustrates a front view of the disclosed adjustable safety harness 10 in place on a child 12 seated on a booster seat 14 placed in a hydraulic professional services chair 16. The harness 10 comprises a waist strap 20 traveling across the child's waist 22 and encircling the chair 16. FIG. 1 further illustrates the crotch strap 24 which is sewn to the front midpoint 26 of the waist strap 20 and travels vertically down between the child's legs and under the booster seat 14 (if one is used).

Further depicted in FIG. 1 are two shoulder straps 28 and a front cross piece 30. The two shoulder straps 28 are sewn to the front of the waist strap 20, one on each side of the crotch strap 24. The two shoulder straps 28 are sewn to the front cross piece 30, or, in an alternate embodiment each end of the front cross piece 30 is folded over and sewn to itself, creating a loop through which the shoulder straps 28 can pass. In either embodiment, the front cross piece 30 keeps the shoulder straps 28 in place, such that they do not fall off the shoulders.

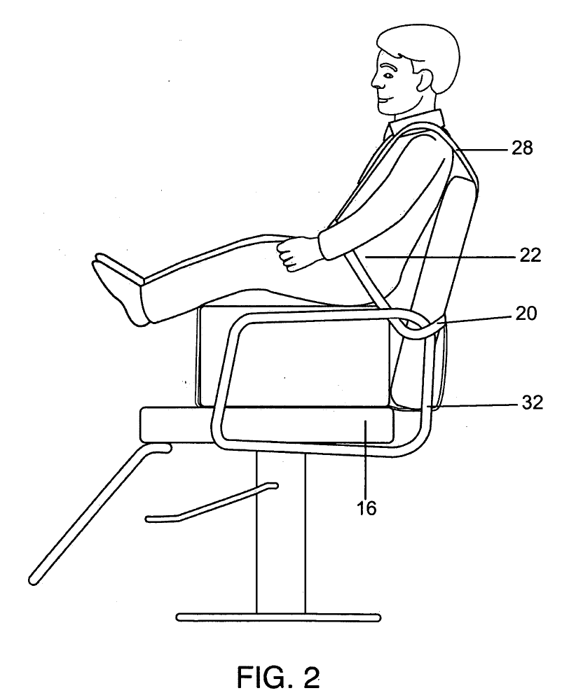

FIG. 2 depicts a side view of the preferred embodiment of the disclosed invention. In FIG. 2, the waist strap 20 is seen traveling across the child's waist 22, under the arm 32 of the chair 16 and traveling around to the rear of the chair 16. Similarly, the shoulder strap 28 is seen traveling over the shoulder and down the rear of the chair 16.

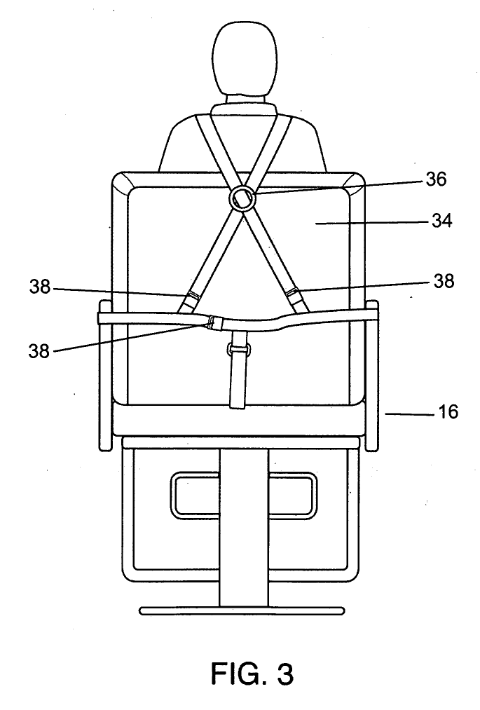

FIG. 3 illustrates the shoulder straps 28 traveling down the posterior back 34 of the chair 16 and passing through a slidable O ring 36, in a criss-cross or X pattern before proceeding down to couple to the rear of the waist strap by two adjustable fasteners 38. The adjustable fasteners 38 are permanently sewn to the rear of the waist strap 20, and the end of the shoulder straps 28 thread through them, securing the shoulder straps 28 to the waist strap 20 and allowing for tightening or loosening of the shoulder straps 28.

FIG. 3 further illustrates an adjustable fastener 38 at one end of the waist strap 20 through which the other free end of the waist strap 20 passes to couple the two ends, yet allow for tightening or loosening of the waist strap 20 as needed. FIG. 3 also depicts how the crotch strap 24 travels up the posterior back 38 of the chair 16 and couples to the waist strap 20 with an adjustable fastener 38 (or other permanent or semi-permanent means) that is sewn to the waist strap.

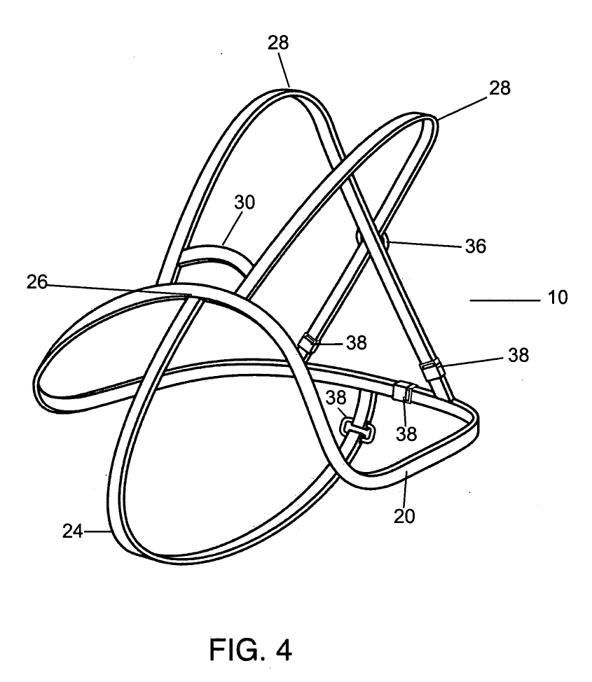

FIG. 4 illustrates the disclosed harness 10 and its parts in a more close up view, with numbers as according to the prior paragraphs, exhibiting a waist strap 20, a crotch strap 24 and two shoulder straps 28. The shoulder straps 28 are connected in the front by a cross piece 30. The two shoulder straps 28 cross in the back by passing through a slidable ring 36. The shoulder straps 28, the waist strap 20, and the crotch strap 24 all are connected using adjustable fasteners.

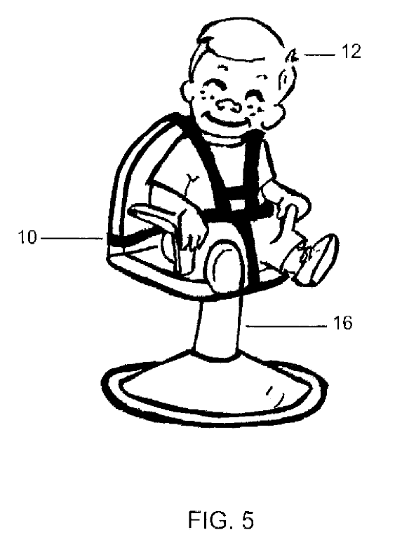

FIG. 5 illustrates the disclosed harness 10 in the preferred embodiment, in use on a child 12 who is sitting on a hydraulic chair 16.

To apply the harness to the person, the professional simply lays the crotch strap vertically over the seat cushion of the chair, placing the booster seat over the crotch strap portion and letting the remainder of the front of the harness dangle down in front of the chair. The posterior end of the crotch strap emerges at the posterior back of the chair, between the back cushion and the seat cushion, or, if the two are sewn together, the crotch strap travels under the whole chair rather than just under the booster seat.

In the case of a child who needs a booster seat, the child is placed on the booster seat and the professional lifts the harness over their head, settling the shoulder straps on the child's shoulders and letting the waist straps fall to the child's sides. In no particular order, the professional couples the waist straps together behind the chair, tightening or loosening as necessary. The professional couples the shoulder straps to the waist strap, again, tightening or loosening as necessary. The professional couples the crotch strap to the waist strap, again tightening or loosening as necessary.

Upon completing the procedure, the professional need only uncouple the waist strap and crotch strap, lifting the harness off the child or person. The same application and removal process applies for taller children or persons who do not need a booster seat.

The straps can all be made of woven cotton, nylon, or natural or artificial fiber fabrics, which can be manufactured by standard techniques, known to those skilled in the art.

In the preferred embodiment, the harness encourages the child or person to be still as the professional performs the procedure, which may include procedures such as hair cuts, various salon treatments, dental examinations and treatments, optometry exams and other professional services where a child or person needs to be still in a seated position.

In the preferred embodiment, the child is less able to wiggle, twist and move but is comfortably and simply restrained.

The disclosure is intended for children or persons able to sit up on their own. It could be used in a variety of professional services chairs, including hydraulic chairs. It could also be used in wheelchairs to prevent a child or person from sliding down in the wheelchair.

While the disclosed harness has been described in conjunction with the preferred embodiments thereof, many changes, modifications, alterations and variations will be apparent to those skilled in the art. Thus, although the invention is described in conjunction with restraining a child in a professional services chair, such as a hydraulic chair, it is also applicable to safety harnesses for restraining children in other situations.

Accordingly, the preferred embodiments of the invention shown in the drawings and described in detail above are intended to be illustrative, not limiting, and various changes may be made without departing from the spirit and scope of the invention as defined by the claims set forth below.

What is claimed is:

1. An adjustable harness for restricting a person's movement while in a professional services chair, comprising:
a waist strap having a first and a second end, the strap traversing horizontally across the person's waist and encircling the chair, wherein the first and second ends of the waist strap culminate in one or more adjustable coupling devices at the back of the chair;
a crotch strap connected to the front midpoint of the waist strap and extending between the person's legs in a vertical path under the chair and extending up the posterior back of the chair to adjustably couple to at least one of the adjustable coupling devices at the back of the chair;
a first and a second shoulder strap, each with a proximate end and a distal end, wherein the proximal ends connect to the waist strap at the person's abdomen on either side of the crotch strap, the straps extending over the shoulders of the person and extending vertically down the person's back, adjustably secured by passing through a slidable ring; each of the distal ends of the shoulder straps adjustably coupled to the waist strap; and
a front cross strap superior to, and generally parallel to the waist strap having two ends that are connected to each of the shoulder straps.

2. The adjustable harness as described in claim 1 wherein at least one of the waist straps, the shoulder straps and the crotch strap adjustably couple using an adjustable slide buckle.

3. The adjustable harness as described in claim 1 wherein the slidable ring is a D ring.

4. The adjustable harness as described in claim 1 wherein the slidable ring is an O ring

5. The adjustable harness as described in claim 1 wherein the person is a child.

6. The adjustable harness as described in claim 1 wherein the straps are adhered using permanent stitching.

7. The adjustable harness as described in claim 1 wherein the shoulder straps cross in a diagonal criss-cross pattern at the back of the chair.

8. The adjustable harness as described in claim 1 wherein the professional services chair is a hydraulic chair.

9. A method for restricting a seated person's movement during a salon procedure by applying an adjustable harness to the person and a professional services chair, the adjustable harness comprising:
a waist strap having a first and a second end, the strap traversing horizontally across the person's waist and encircling the chair, wherein the first and second ends of the waist strap culminate in one or more adjustable coupling devices at the back of the chair;
a crotch strap connected to the front midpoint of the waist strap and extending between the person's legs in a vertical path under the chair and extending up the posterior back of the chair to adjustably couple to at least one of the adjustable coupling devices at the back of the chair;
a first and a second shoulder strap, each with a proximate end and a distal end, wherein the proximal ends connect to the waist strap at the person's abdomen on either side of the crotch strap, the straps extending over the shoulders of the person and extending vertically down the person's back, adjustably secured by passing through a slidable ring; each of the distal ends of the shoulder straps adjustably coupled to the waist strap; and
a front cross strap superior to, and generally parallel to the waist strap having two ends that are connected to each of the shoulder straps.

10. The adjustable harness as described in claim 9 wherein at least one of the waist straps, the shoulder straps and the crotch strap adjustably couple using an adjustable slide buckle.

11. The adjustable harness as described in claim 9 wherein the slidable ring is a D ring.

12. The adjustable harness as described in claim 9 wherein the slidable ring is an O ring

13. The adjustable harness as described in claim 9 wherein the person is a child.

14. The adjustable harness as described in claim 9 wherein the straps are adhered using permanent stitching.

15. The adjustable harness as described in claim 9 wherein the shoulder straps cross in a diagonal criss-cross pattern at the back of the chair.

16. The adjustable harness as described in claim 9 wherein the professional services chair is a hydraulic chair.
